(19) United States
(12) Patent Application Publication
(10) Pub. No.: US 2008/0107906 A1
(43) Pub. Date: May 8, 2008

(54) METHOD FOR PREPARING POLYMER ACTUATORS WITH HIGH STABILITY AND POLYMER ACTUATORS PREPARED BY THE METHOD

(75) Inventors: Nak Jin Choi, Daejeon (KR); Jung Hyun Lee, Daejeon (KR); Kang Ho Park, Daejeon (KR); Hyo Young Lee, Daejeon (KR); Hyung Kun Lee, Daejeon (KR); Jong Dae Kim, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/856,484

(22) Filed: Sep. 17, 2007

(30) Foreign Application Priority Data
Nov. 8, 2006 (KR) 10-2006-0109745
Jun. 1, 2007 (KR) 10-2007-0053741

(51) Int. Cl. B32B 27/06; B05D 5/12; B32B 15/08

(52) U.S. Cl. 428/422; 427/123; 428/457

(57) ABSTRACT

Provided are a method for preparing polymer actuators with high stability and polymer actuators prepared by the method, and more specifically, to a method for preparing polymer actuators with high stability that use low power, are extremely thin, and can be substituted in a motor of a camera module, and polymer actuators prepared by the method. The method includes the steps of: preparing an Ionic Polymer Metal Composite (IPMC) in which metal electrodes are plated on both surfaces of a ionic polymer film; removing water from the ionic polymer film of the IPMC; and expanding the IPMC in a polar solvent that has a higher boiling point and a lower freezing point than water.

### CROSS-REFERENCE TO RELATED APPLICATION

This application claims priority to and the benefit of Korean Patent Application Nos. 2006-109745, filed Nov. 8, 2006 and 2007-53741, filed Jun. 1, 2007, the disclosures of which are incorporated herein by reference in their entirety.

### BACKGROUND

1. Field of the Invention

The present invention relates to a method for preparing polymer actuators with high stability and polymer actuators prepared by the method, and more specifically, to a method for preparing polymer actuators with high stability that use low power, are extremely thin, and can be substituted in a motor of a camera module, and polymer actuators prepared by the method.

2. Discussion of Related Art

Recently, many scientists are researching Ionic Polymer Metal Composite (IPMC), which is an Electro-Active Polymer (EAP) [refer to: Geoffrey M. Spinks, etc., SPIE, 5051, 2003, 21-28].

IPMC has the advantages of low power consumption, a large displacement at low voltage, and a rapid response characteristic at high frequency.

IPMC is a composite of conductive metal and an ionic polymer film substituted with fluorine and is formed in a shape having metal electrodes plated on both surfaces of a Nafion™ film. When an electric field is applied to the metal electrodes, the film is partially expanded and bent through migration of ions within the film. Because of this characteristic of the film, it is deformed under the electrical field. The degree of deformation can be adjusted in accordance with the magnitude or frequency of a voltage applied to the electrodes positioned on both surfaces of the film [refer to Barbar J. Akle and Donald J. Leo, SPIE, 5051, 2003, 214-225].

FIG. 1 shows the operation principle of the IPMC. As shown in FIG. 1, when a voltage is applied to the metal electrodes plated on both surfaces of the Nafion™ film, cations and a polar solvent migrate in a direction opposite to the direction of the applied voltage such that the film is deformed.

In many actuators, water is used as a polar solvent, which is easily prepared. However, the use of water is limited to an extremely high or extremely low temperature range, because of the boiling point and freezing point of water. For example, water is hard to use in a sub-zero temperature, and the stability of water decreases at high temperatures required for manufacturing a module. To solve this problem, many scientists use ionic liquid having advantages in freezing point and boiling point (refer to Matthew D. Bennett and Donald J. Leo, SPIE, 5385, 2004, 210-220, and Doyeon Kim and Kwang J. Kim, SPIE, 6168, 2006, 61681X).

Thus, the present inventors researched a solution to the problems of the related art. Further, the inventors found that, when polymer actuators are prepared using a polar solvent, particularly, propylene carbonate which has a lower freezing point and a higher boiling point than water, it is possible to prepare polymer actuators which can be used at low temperatures and can be used even after extremely high-temperature treatment is performed.

### SUMMARY OF THE INVENTION

The present invention is directed to a method for preparing polymer actuators with high stability using a polar solvent, which has a lower freezing point and a higher boiling point than water. Therefore, the polymer actuators can be used at low temperatures and can be used even after extremely high-temperature treatment is performed.

The present invention is also directed to polymer actuators with high stability, which can be used at low and high temperatures.

One aspect of the present invention provides a method for preparing polymer actuators with high stability including the steps of: preparing an Ionic Polymer Metal Composite (IPMC) in which metal electrodes are plated on both surfaces of a ionic polymer film; removing water from the ionic polymer film of the IPMC; and expanding the IPMC in a polar solvent that has a higher boiling point and a lower freezing point than water.

In the step of preparing the IPMC, the ionic polymer film may be a Nafion™ film.

In the step of removing the water, the water may be dried at a temperature of 100 to 120° C. for 10 to 14 hours.

In the step of expanding the IPMC, a propylene carbonate solution may be used as the polar solvent that has a higher boiling point and a lower freezing point than water. The propylene carbonate solution may be prepared by mixing propylene carbonate and methanol in a weight ratio of 1.5:1 to 2.5:1.

The method may further include the step of removing the methanol within the propylene carbonate solution through drying, after expanding the ionic polymer metal composite.

Another aspect of the present invention provides polymer actuators which are prepared by a method for preparing polymer actuators with high stability. The method includes the steps of: preparing an IPMC in which metal electrodes are plated on both surfaces of a ionic polymer film; removing water from the ionic polymer film of the IPMC; and expanding the IPMC in a polar solvent that has a higher boiling point and a lower freezing point than water.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 shows the operation principle of an IPMC;

FIG. 2 is a flowchart showing a method for preparing polymer actuators with high stability according to an exemplary embodiment;

FIG. 3 is a diagram showing a method of substituting propylene carbonate for water as a polar solvent;

FIGS. 4A and 4B are graphs showing displacement characteristics of polymer actuators prepared according to an exemplary embodiment of the invention; and

FIG. 5 is a graph showing long-term stability of the polymer actuators prepared according to an exemplary embodiment of the invention.

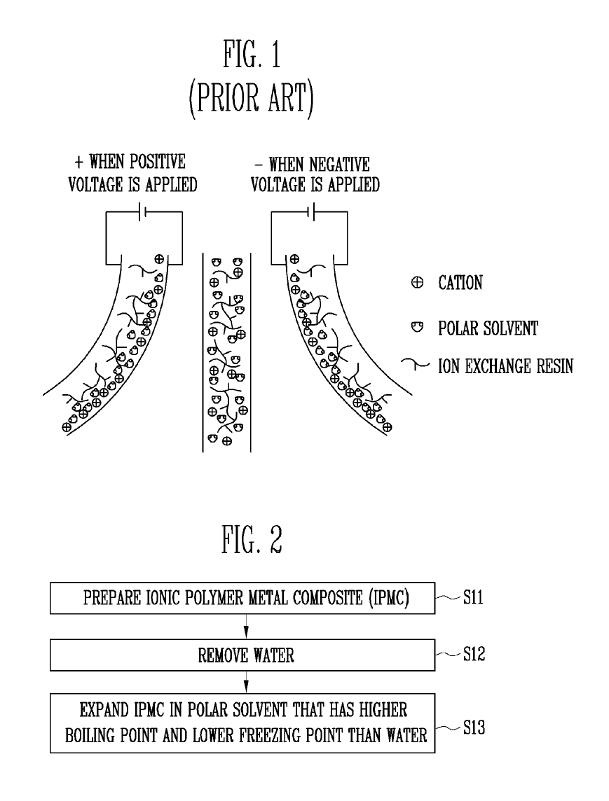

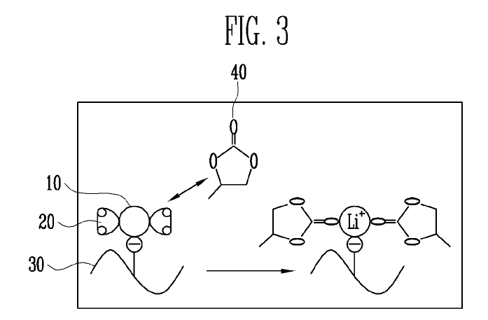

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

A method for preparing polymer actuators with high stability includes preparing an Ionic Polymer Metal Composite (IPMC) in which metal electrodes are plated on both surfaces of a ionic polymer film (S11); removing water from the ionic polymer film of the IPMC (S12); and expanding the IPMC in a polar solvent that has a higher boiling point and a lower freezing point than water (S13).

In preparing the IPMC (S11), the composite is prepared by plating metal electrodes on both surfaces of the ionic polymer film.

The ionic polymer film can be any used in this field. Preferably, a Nafion™ film can be used. Further, the metal electrodes can be any used in this field. Preferably, platinum or gold can be used. The metal electrodes can be plated to a thickness which is generally applied in this field. Preferably, the metal electrodes are plated to a thickness of 5 to 10 μm.

An electroplating method for plating metal electrodes on both surfaces of the ionic polymer film is based on a method used by Oguro group (refer to K. Oguro, http://ndeaajpl.nasa.gov/nasa-nde/lommas/eap/IPMC_htm). Through the electroplating method, the ionic polymer film can be bent by an electric device. The case where Nafion 117 is used as the ionic polymer film will be described as follows.

1) Surface Treatment: Surface treatment is performed to enhance a surface adhesive force of the Nafion film. Surface roughness is increased through mild sandblast, ultrasonic cleaning, HCl treatment (using 2NHCl aqueous solution), and water treatment (using deionized water).

2) Ion Exchange (Adsorption): A platinum complex (for example, [Pt(NH₃)₄]Cl₂ or [Pt(NH₃)₆]Cl₄ is used) is used to substitute a Pt ionic functional group ([Pt(NH₃)₄]+²) for H⁺ of a sulfonic functional group (—SO₃H) which is a hydrophilic group of Nafion.

3) Primary Plating (Reduction): Platinum salt adsorbed into the Nafion is reduced to platinum metal.

NaBH₄+4[Pt(NH₃)₄]²⁺+8OH⁻→4Pt⁰(s)+16NH₃(g)+NaBO₂+6H₂O(l)

4) Secondary Plating (Making Surface into Electrode): Metal (platinum) is added onto the platinum layer on the surface of the ionic polymer film.

5) Ion Exchange: H ions existing in the Nafion are substituted with Li ions.

As such, platinum electrodes are plated on the Nafion film, and NaBH₄ is used as a reducing agent. The Li ions migrate to deform the film.

In removing the water (S12), water is removed from the IPMC and replaced with another solvent as a polar solvent.

The water can be removed when the IPMC is dried at a temperature higher than the boiling point of water for a proper time. Although the drying temperature and the time can be adjusted depending on the amount of water and the shape and size of the composite, it is preferable that the water is evaporated at a temperature of 100 to 120° C. for 10 to 14 hours. When the IPMC is dried at a temperature exceeding 120° C., the time can be reduced, but the IPMC can be damaged. Therefore, it is not preferable that the IPMC is dried at a temperature exceeding 120° C.

In expanding the IPMC (S13), the IPMC is expanded in a polar solvent which is substituted for water.

The polar solvent which is substituted for water is preferably a solvent which has a lower freezing point and a higher boiling point than water. Further, the IPMC is held and expanded in the polar solvent for 1 to 24 hours.

Specifically, the polar solvent is preferably a solution of methanol and propylene carbonate, which has the following chemical formula and has a lower freezing point (−49° C.) and a higher boiling point (242° C.) than water.

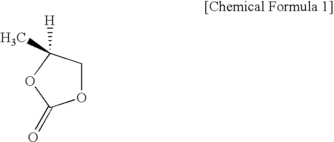

In this case, it is preferable that propylene carbonate and methanol are mixed in a weight ratio of between 1.5:1 to 2.5:1.

Subsequently, to remove the methanol, the IPMC is dried at a temperature of 100 to 120° C. for two to four hours.

The polymer actuators according to the invention can be prepared using the above-described method for preparing polymer actuators. Since the polar solvent, which has a lower freezing point and a higher boiling point than water, is used instead of water, stability at low and high temperature is improved.

In the polymer actuators according to the invention, a process where propylene carbonate is substituted for water molecules can be illustrated as shown in FIG. 3.

Referring to FIG. 3, the water molecules 20 coming in contact with positive ions 10 of the Nafion film are substituted with the propylene carbonate 40 such that the propylene carbonate 40 comes in contact with the positive ions 10 of the Nafion film.

Hereinafter, an exemplary embodiment of the invention will be described so that the invention can be easily embodied by those skilled in the art.

### Embodiment

Increasing Surface Roughness of Film

To increase the surface area of a Nafion film (Nafion 117 made by DuPont), the surface of the Nafion film is sandblasted using minute glass beads (GP 105A made by Toshiba Co., Ltd.). The sand blasting is performed at a speed of one second per film area (cm²).

Ion Exchange (Adsorption)

Subsequently, a solution containing 2 mg of platinum complex ([Pt(NH₃)₄]Cl₂) per 1 ml is prepared, and the film is held in a solution containing more than 3 mg of Pt per film area (cm²). For example, more than 45 ml of Pt solution is required for a film having an area of 30 cm². After the film is held, 1 ml of ammonium hydroxide solution (5%) is added for neutralization. The film is maintained in the solution at room temperature overnight.

Primary Plating (Reduction)

The film is cleaned using water, and 2 ml of sodium borohydride solution (5 wt % NaBH₄ aq) is added seven times every 30 minutes into a water tank containing 180 ml of 40° C. agitation water into which the film having an area of 30 cm² is put. The amount of sodium borohydride solution should be proportional to the area of the film. Then, the temperature is gradually increased to 60° C., 20 ml of reducing agent (NaBH₄) is added, and agitating is performed at a temperature of 60° C. for one and a half hours. Then, a black layer of fine Pt particles is adsorbed on the surface of the film. The film is cleaned using water and then held in diluted hydrochloric acid (0.1 N) for one hour.

Secondary Plating (Developing)

The amount of platinum adsorbed by the primary plating is equal to or less than 0.9 mg/cm², depending on ion exchange capacity, the thickness of the film, and the structure of the platinum complex. An added amount of platinum is plated on the deposited Pt layer by secondary plating. When 2 mg/cm² of platinum is added with respect to an area of 60 cm², 240 ml of platinum complex ([Pt(NH₃)₄]Cl₂) solution containing 120 mg of Pt is prepared, and 5 ml of ammonium hydroxide (5%) is added to this solution. The plating amount is determined by the amount of Pt in the solution. The film is put into the Pt solution agitated at a temperature of 40° C., and 6 ml of 5% hydroxylamine hydrochloride aqueous solution (NH₂OH—HCl) and 3 ml of 20% hydrazine solution are added for 30 minutes. After adding, the temperature is gradually increased to 60° C. over four hours. Then, a gray metal layer is formed. At the end of this process, a small amount of solution is sampled and then boiled with a reducing agent (NaBH₄) so as to check an end point. If Pt ions remain in the plating solution, NH₂OH—HCl and NH₂NH₂ solutions are added so that Pt is continuously formed. Otherwise, if Pt ions do not remain in the plating solution, the film is cleaned using water and boiled in diluted hydrochloric acid (0.1 N) to remove positive ammonium ions within the film. After the film is cleaned using water, H⁺ within the film is exchanged for positive ions by holding the film in a solution containing chloride salt of positive ions. Then, an IMPC is prepared.

Substituting Propylene Carbonate for Water

The IPMC is dried in a vacuum oven of 110° C. for 12 hours. Then, while being heated to 60° C., the IPMC is held in a propylene carbonate solution in which propylene carbonate and methanol are mixed in a weight ratio of 2:1. To remove the methanol used in the above-described process, the IMPC is dried in a vacuum oven at 10° C. for three hours. This completes the preparation of polymer actuators with high stability in which propylene carbonate is substituted for water.

### Experimental Example

To examine characteristics of the actuators prepared in the above-described embodiment, a displacement characteristic and a long-term stability characteristic are measured.

Displacement Characteristic

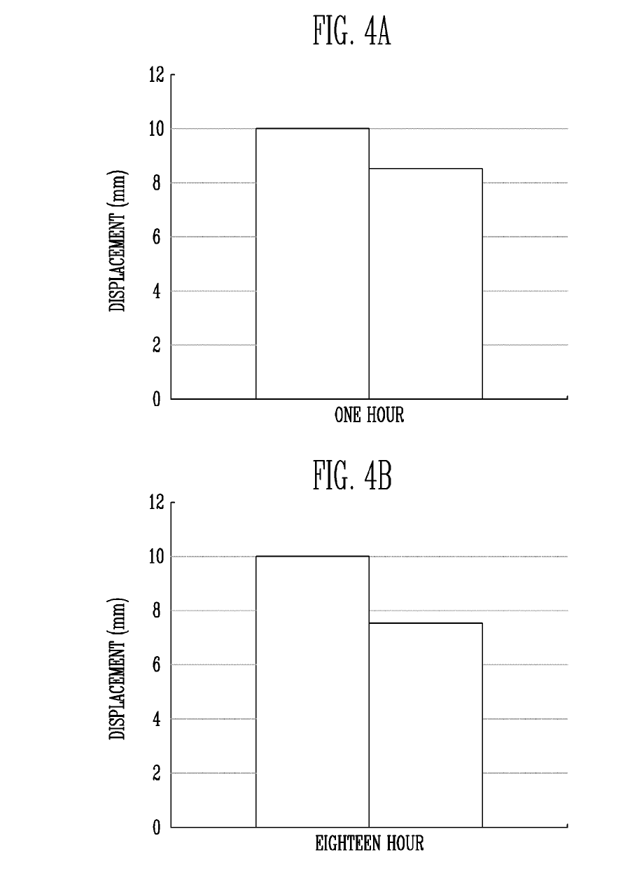

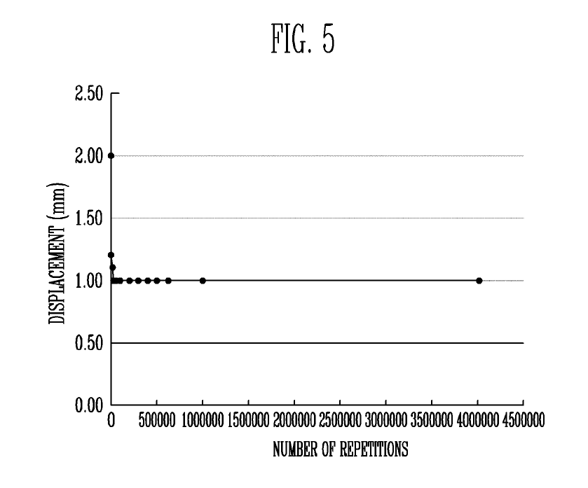

To check if the polymer actuators can operate after high-temperature treatment, the polymer actuators prepared in the above-described embodiment were kept in an electric oven at 120° C. for 1 hour and for 18 hours, respectively, and displacement characteristics were then measured. FIGS. 4A and 4B show the results.

FIG. 4A shows displacement characteristic measurements taken after the polymer actuators were kept in an electrical oven at 120° C. for 1 hour. In FIG. 4A, a front bar graph indicates a value before high-temperature treatment was performed, and a rear bar graph indicates a value after high-temperature treatment was performed. As shown in FIG. 4A, even after high-temperature treatment was performed, the displacement characteristic of the polymer actuators was similar to their initial displacement characteristic, even after a predetermined time.

FIG. 4B shows displacement characteristic measurements taken after the polymer actuators were kept in an electrical oven at 120° C. for 18 hours. In FIG. 4B, a front bar graph indicates a value before high-temperature treatment was performed, and a rear bar graph indicates a value after high-temperature treatment was performed. As shown in FIG. 4B, the displacement characteristic of the polymer actuators decreased compared to when the polymer actuators were kept for 1 hour. However, the displacement characteristic of the polymer actuators was similar to their initial displacement characteristic.

Long-Term Stability

FIG. 5 shows measurements of displacement and the number of drives when a voltage of 3V is applied to the polymer actuators, prepared in the above-described embodiment, by using a frequency generator outputting a frequency of 1 Hz. As shown in FIG. 5, stability was maintained until a 4×10⁶th round of driving was performed.

According to the invention, the polar solvent is propylene carbonate rather than water, which enables the polymer actuators to be used at low temperatures and even after extremely high-temperature treatment. This means that the characteristics of the polymer actuators do not change even in high-temperature treatment which is required when a module is manufactured. Therefore, the polymer actuators can be used in mass production.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for preparing polymer actuators with high stability, the method comprising the steps of:
preparing an Ionic Polymer Metal Composite (IPMC) in which metal electrodes are plated on both surfaces of a ionic polymer film;
removing water from the ionic polymer film of the IPMC; and
expanding the IPMC in a polar solvent that has a higher boiling point and a lower freezing point than water.

2. The method of claim 1, wherein the ionic polymer film is a Nafion™ film.

3. The method of claim 1, wherein the polar solvent is a propylene carbonate solution.

4. The method of claim 1, wherein in the step of removing the water, the water is evaporated at a temperature of 100 to 120° C. for 10 to 14 hours.

5. The method of claim 3, wherein the propylene carbonate solution is prepared by mixing propylene carbonate and methanol in a weight ratio of 1.5:1 to 2.5:1.

6. The method of claim 5, further comprising the step of removing the methanol within the propylene carbonate solution through drying, after expanding the ionic polymer metal composite.

7. Polymer actuators prepared according to the method of claim 1.

8. Polymer actuators prepared according to the method of claim 2.

9. Polymer actuators prepared according to the method of claim 3.

10. Polymer actuators prepared according to the method of claim 4.

11. Polymer actuators prepared according to the method of claim 5.

12. Polymer actuators prepared according to the method of claim 6.
